(19) United States
(12) Patent Application Publication
(10) Pub. No.: US 2010/0054300 A1
(43) Pub. Date: Mar. 4, 2010

(54) Temperature-sensing undergarment

(76) Inventor: Chi-Sheng Tsai, Taipei City (TW)

Correspondence Address: Chi-Sheng,TSAI, P.O. BOX 46-563 Taipei, Taipei City 10499, 104, TW

(21) Appl. No.: 12/229,859

(22) Filed: Aug. 28, 2008

(51) Int. Cl. G01K 1/00

(52) U.S. Cl. 374/141; 340/584; 374/E01.001

(57) ABSTRACT

A temperature-sensing undergarment is provided. The temperature-sensing undergarment primarily includes a garment body, at least one temperature-sensing device and a processing device. The garment body is provided with a receiving pocket, from which at least one conductor is extended to two armpit portions of the garment body. When the garment body is worn on a human body, the temperature-sensing devices disposed at the two armpit portions of the garment body will sense the body temperature and transmit a temperature-sensing signal to the processing device via the conductor. Thus, variation of the body temperature can be detected continuously.

### BACKGROUND OF THE INVENTION

1. Technical Field

The present invention relates to a temperature-sensing undergarment, and more particularly, to a garment structure capable of sensing a body temperature continuously.

2. Description of Related Art

In most cases, variation of the body temperature is an indication of health conditions. Common devices for measuring the body temperature generally fall into two categories, namely, mercury thermometers and electronic thermometers. A mercury thermometer primarily works on the physical phenomenon of thermal expansion and contraction of mercury. When the mercury expands in response to the body temperature, a user can read the body temperature by checking the mercury level against the scale on the thermometer. Although the mercury thermometers have a low price, they need to be shaken before use to reset the mercury level to zero and take a long time to sense and measure the body temperature. In addition, as the measured sites are mostly limited to the armpits, anus and hypoglossis, hygiene becomes an important concern. Furthermore, the mercury thermometers are liable to fracture under external impact, causing danger in use. On the other hand, an electronic thermometer senses and indicates a body temperature electronically. Although the electronic thermometer senses the body temperature in a rapid way and is less liable to damage under external impact, the measured sites are still mostly limited to the armpits, anus and hypoglossis, just as in the case of the mercury thermometers, so that hygiene is also an important concern. In addition to the above shortcomings, the most prominent drawback of the mercury thermometers and the electronic thermometers is that both of them belong to passive temperature-sensing devices which are unable to track the body temperature on a continuous basis, making it impossible for a person experiencing abnormal variation of the body temperature to take immediate and appropriate measures.

Accordingly, prevention of the above problems has become a technical challenge for the inventor of the present invention.

### BRIEF SUMMARY OF THE INVENTION

A primary objective of this invention is to provide a temperature-sensing undergarment, wherein a garment body is provided with a receiving pocket in which a processing device is placed, and at least one conductor is extended from the receiving pocket to two armpit portions of the garment body to be connected with temperature-sensing devices located at the two armpit portions. With this arrangement, the temperature-sensing devices will sense the body temperature and transmit a temperature-sensing signal to the processing device via the conductor in the garment, so that variation of the body temperature can be known at any time.

A second objective of this invention is to provide each of the temperature-sensing devices at the armpit portions of the garment body with a temperature-sensing chip for sensing the body temperature, and to encapsulate the temperature-sensing chip with an encapsulation layer made of a waterproof resin. Hence, the temperature-sensing devices can be put into water along with the garment body to be washed, thus facilitating a washing process of the temperature-sensing undergarment.

### BRIEF DESCRIPTION OF THE SEVERAL VIEWS OF THE DRAWINGS

The invention as well as a preferred mode of use, further objectives and advantages thereof will be best understood by referring to the following detailed description of illustrative embodiments when read in conjunction with the accompanying drawings, wherein:

FIG. 1 is a perspective view of this invention;

FIG. 2 provides schematic partial views of this invention;

FIG. 3 is another schematic partial view of this invention;

FIG. 4 is yet another schematic partial view of this invention;

FIG. 5 shows a preferred embodiment of this invention; and

FIG. 6 is another view of the preferred embodiment of this invention.

### DETAILED DESCRIPTION OF THE INVENTION

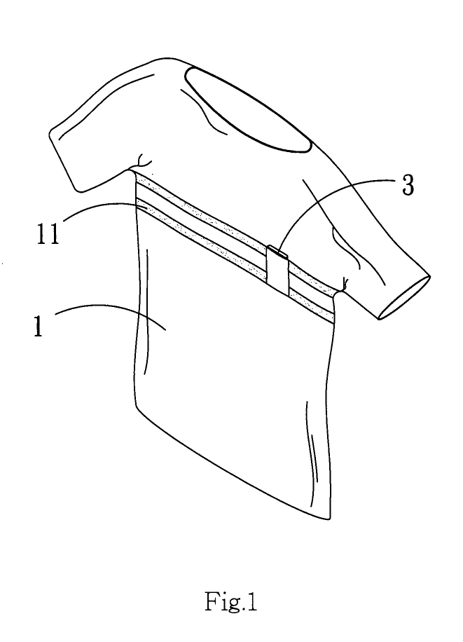

Referring to FIGS. 1, 2, 3 and 4, wherein a perspective view and schematic partial views of this invention are provided, a garment body 1 is provided with a receiving pocket 10, from which at least one conductor 11 is extended to two armpit portions of the garment body 1. Both the receiving pocket 10 and the conductor 11 are made of stainless steel staple fibers. The receiving pocket 10 has a processing device 3 disposed therein while the conductors 11 are extended to the two armpit portions to be connected with two temperature-sensing devices 2 provided respectively in the two armpit portions. A temperature-sensing chip 21 is provided in each of the temperature-sensing devices 2 for sensing an armpit temperature, and is encapsulated by an encapsulation layer 22 made of a waterproof resin. Two ends of each of the temperature-sensing devices 2 is provided with at least one signal contact 23 made of a nickel-based conductive paste so as to make contact with the conductors 11. On the processing device 3, at least one receiving contact 31 made of a nickel-based conductive paste is provided to make contact with the receiving pocket 10 and the conductors 11. An indicator element 32 is further provided on the processing device 3 to emit an alarming light when an abnormal body temperature is detected.

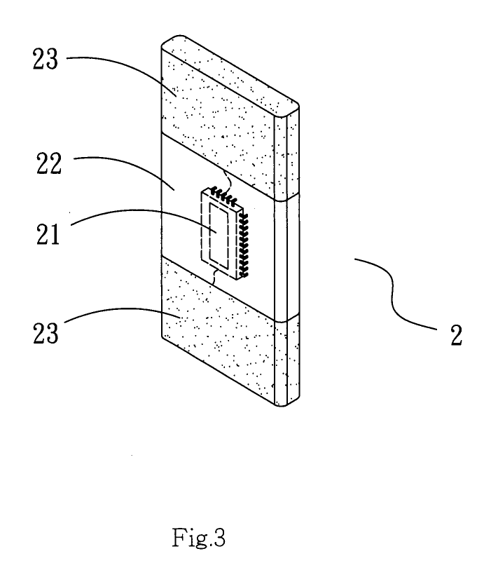

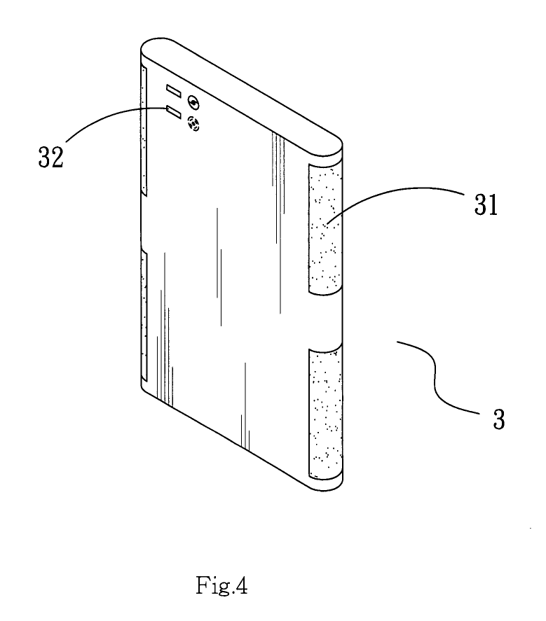

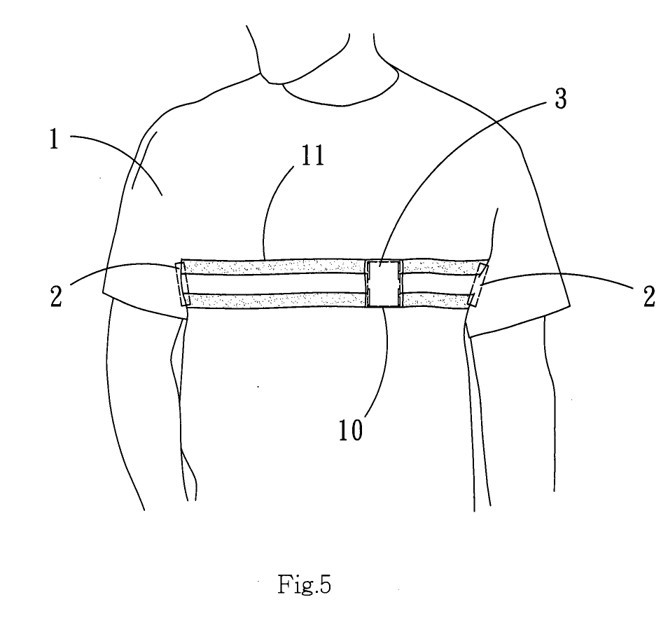

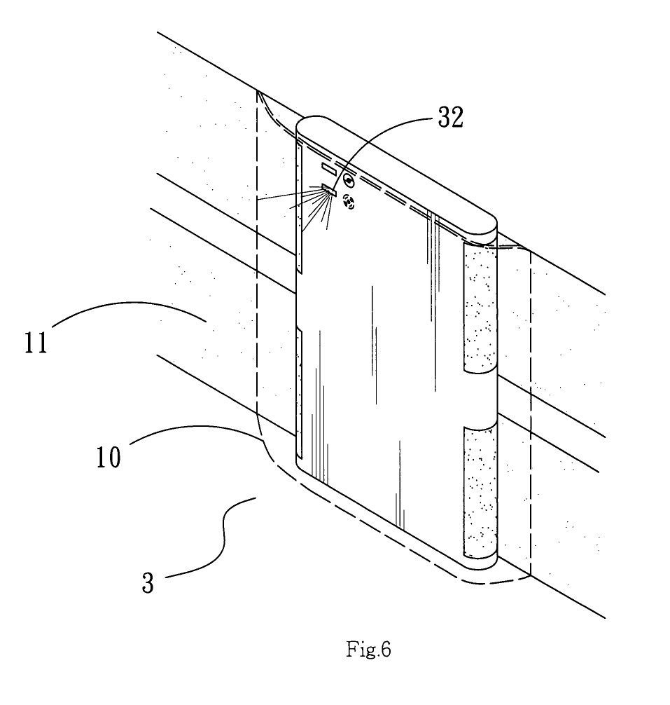

Referring to FIGS. 5 and 6 (in conjunction with FIGS. 3 and 4) for a preferred embodiment of this invention, when the garment body 1 is worn on a human body, the temperature-sensing chip 21 in each of the temperature-sensing devices 2 disposed at the two armpit portions of the garment body 1 will sense the body temperature continuously and, via the signal contacts 23 made of the nickel-based conductive paste at the two ends of each of the temperature-sensing devices 2, transmit a temperature-sensing signal to the receiving pocket 10 through the conductors 11 made of stainless steel staple fibers in the garment body 1. Then, the receiving contacts 31 made of the nickel-based conductive paste on the processing device 3 receive the temperature-sensing signal transmitted from the temperature-sensing devices 2 through the conductors 11. In case the body temperature detected by the temperature-sensing devices 2 is abnormal, the indicator element 32 on the processing device 3 immediately emits the alarming light to indicate the abnormal body temperature, so that a wearer can take appropriate measures. Additionally, since the temperature-sensing chip 21 in each of the temperature-sensing devices 2 disposed at the two armpit portions of the garment body 1 is encapsulated by the encapsulation layer 22 made of the waterproof resin, the temperature-sensing devices 2 can be put into water together with the garment body 1 to be washed without causing damage to the temperature-sensing chips 21 due to water incursion.

With the structure and arrangement described above, it is possible to detect and monitor variation of the body temperature on a continuous basis, so that a user, particularly a bedridden, immobile or elderly patient, can monitor his/her body temperature continuously and take necessary measures in a timely manner.

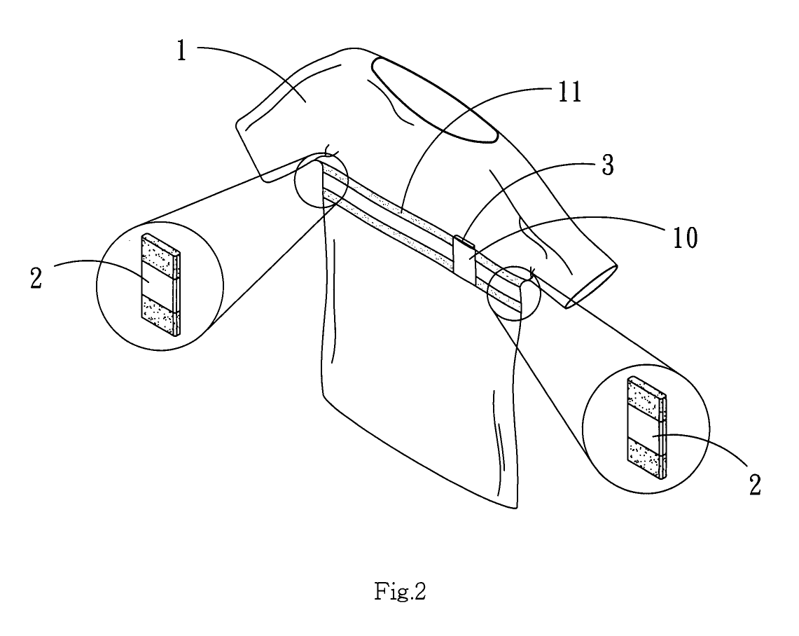

Please refer to Table 1 below (in conjunction with FIG. 2) for a comparison of different materials used in this invention. As can be seen clearly in the table, after tests were performed on stainless steel filaments, stainless steel staple fibers and silver staple fibers under dirty, tensioned as well as low- and high-temperature conditions respectively, the stainless steel staple fibers are found to have superior performance over the other two materials. Therefore, the stainless steel staple fibers are chosen to make both the receiving pocket 10 and the conductors 11 of the garment body 1.

TABLE 1

| | | Conductive | | | | |
|---|---|---|---|---|---|---|
| | | property | | | | |
| | | when | | | | |
| | | dirtied | | | | |
| | | Put into a | Conductive | | | |
| | | washing | property | Conductive | Conductive | |
| | Conductive | machine | under | property at | property at | |
| | property | and | tension | low | high | |
| | prior to test | washed 10 | Tensioned | temperature | temperature | |
| | Measured | times, with | by a load | Rest at | Rest at | |
| | with a | dust added | of 10 kg for | −10° C. for 4 | 85° C. for 4 | |
| Material | multimeter | in water | 72 hours | hours | hours | Result |
| Stainless | 35 Ω/m | 40 Ω/m | 300 Ω/m | 40 Ω/m | 40 Ω/m | x |
| steel | | | | | | |
| filaments | | | | | | |
| Stainless | 40 Ω/m | 75 Ω/m | 50 Ω/m | 52 Ω/m | 60 Ω/m | [symbol] |
| steel | | | | | | |
| staple | | | | | | |
| fibers | | | | | | |
| Silver | 20 Ω/m | 50 Ω/m | 40 Ω/m | 42 Ω/m | 36 Ω/m | [symbol] |
| staple | | | | | | |
| fibers | | | | | | |

Please refer to Table 2 below (in conjunction with FIGS. 3 and 4) for a comparison of another group of different materials used in this invention. As can be seen clearly in the table, after tests were performed on conductive pastes based on carbon powder, nickel and silver under dirty, tensioned as well as low- and high-temperature conditions respectively, the nickel-based conductive paste is found to have superior performance over the other two materials. Therefore, the nickel-based conductive paste is chosen to make both the signal contacts 23 of the temperature-sensing devices 2 and the receiving contacts 31 of the processing device 3.

TABLE 2

| | | Conductive | | | | |
|---|---|---|---|---|---|---|
| | | property | | | | |
| | | when | | | | |
| | | dirtied | | | | |
| | | Put into a | | | | |
| | | washing | Conductive | | | |
| | | machine | property | Conductive | Conductive | |
| | Conductive | and | under | property at | property at | |
| | property | washed for | tension | low | high | |
| | prior to test | 1 hour, | Tensioned | temperature | temperature | |
| | Measured | with dust | by a load | Rest at | Rest at | |
| | with a | added in | of 1 kg for | −10° C. for 4 | 85° C. for 4 | |
| Material | multimeter | water | 72 hours | hours | hours | Result |
| Carbon | 2 Ω/cm³ | 3 Ω/cm³ | 2.5 Ω/cm³ | 3 Ω/cm³ | 3 Ω/cm³ | x |
| powder | | | | | | |
| Nickel | 0 Ω/cm³ | 0.7 Ω/cm³ | 1 Ω/cm³ | 1 Ω/cm³ | 1 Ω/cm³ | [symbol] |
| Silver | 0 Ω/cm³ | 0 Ω/cm³ | 0 Ω/cm³ | 0 Ω/cm³ | 0 Ω/cm³ | [symbol] |

1. A temperature-sensing undergarment, comprising:
a garment body provided with a receiving pocket and at least one conductor extended from the receiving pocket to an armpit portion of the garment body;
at least one temperature-sensing device disposed at the armpit portion of the garment body and connected with the conductor; and
a processing device disposed inside the receiving pocket of the garment body for receiving a temperature-sensing signal from the temperature-sensing device via the conductor;
wherein the temperature-sensing device senses a wearer's body temperature at armpits and transmits the temperature-sensing signal to the processing device via the conductor, so that the wearer can monitor variation of the body temperature at any time;
wherein the conductor and the receiving pocket are made of stainless steel staple fibers;
wherein the temperature-sensing device comprises a temperature-sensing chip;
wherein the temperature-sensing chip is encapsulated by a waterproof layer made of a resin;
wherein the temperature-sensing device is provided with at least one signal contact for contacting the conductor in the garment body;
wherein the signal contact of the temperature-sensing device is made of a nickel-based conductive paste;
wherein the processing device is provided with at least one receiving contact which is connected with the conductor when the processing device is placed inside the receiving pocket of the garment body;
wherein the receiving contact of the processing device is made of a nickel-based conductive paste;
wherein the undergarment can be washed by washing machine.

2. (canceled)

3. (canceled)

4. (canceled)

5. (canceled)

6. (canceled)

7. (canceled)

8. (canceled)

9. The temperature-sensing undergarment as claimed in claim 1, wherein the processing device is provided with an indicator element which emits an alarming light when the body temperature is abnormal.
